(19) United States
(12) Patent Application Publication
(10) Pub. No.: US 2005/0183579 A1
(43) Pub. Date: Aug. 25, 2005

(54) Tea bag squeezer

(76) Inventor: Gary L. Bowers, Woodbury, CT (US)

Correspondence Address: James G. Coplit, Esq.;Grimes & Battersby, LLP, Third Floor, 488 Main Avenue, Norwalk, CT, 06851, US

(21) Appl. No.: 11/064,607

(22) Filed: Feb. 24, 2005

Related U.S. Application Data
(60) Provisional application No. 60/547,288, filed on Feb. 24, 2004.

(51) Int. Cl. A47J 31/00

(52) U.S. Cl. 99/279

(57) ABSTRACT

A tea bag squeezer is provided comprising pair of complementary opposing members, said members each being concave in shape and having a tab extending from one end thereof. The members are attached to each other by means of a flexible hinge disposed between the concave members and the tabs. A spring is disposed at the flexible hinge, which spring serves to force the concave members against each other. A user can separate the concave members to thereby accept a tea bag by biasing squeezing the tab elements to thereby bias them towards each other. The concave members may thereafter be allowed to close about and squeeze the tea bag by releasing said tab members and allowing the force of the spring to compress the teabag or other item between the concave members. Ribbed elements may be provided on the inner surface of the concave members to further squeeze the item placed therein and direct the liquid out of the squeezer. In the preferred embodiment, the squeezer is configured in an aesthetically pleasing design, such as that of a scallop shell. Notches may be included on the surface of the squeezer to receive the string from the squeezer.

### RELATED APPLICATIONS

This is a non-provisional patent application claiming benefit of priority of co-pending U.S. Provisional Patent Application No. 60/547,288 filed on Feb. 24, 2004 in the name of Gary Bowers for “Tea Bag Squeezer.”

### BACKGROUND OF THE INVENTION 1. Field of the Invention

The present invention relates generally to a tea bag squeezer, and more particularly, to a tea bag squeezer comprising a hinged device having opposing jaws for squeezing a teabag and for storing the used teabag until discarded, and even more particularly to such a tea bag squeezer designed to emulate a scallop shell.

2. Description of the Prior Art

Devices for squeezing or compressing tea bags or other objects, such as lemons or limes, have long been known in the art. Most of these devices comprise a pair of complementary plates or surfaces between which the item to be squeezed is placed, wherein the surfaces are connected to each other, usually by means of a spring or hinge. Examples of such devices are disclosed in U.S. Pat. No. 782,406, which issued to Mayhew, et al. on Feb. 14, 1905 for “Squeezer”; U.S. Pat. No. 1,756,250, which issued to Kreuter on Apr. 29, 1930 for “Juice Extractor”; U.S. Pat. No. 1,875,678, which issued to Thate on Sep. 6, 1932 for “Citrus Fruit Juice Extractor”; U.S. Pat. No. 2,699,109, which issued to Schwab on Jan. 11, 1955 for “Fruit Juice Extractor”; U.S. Pat. No. 2,735,360, which issued to Battke on Feb. 21, 1956 for “Lemon Slice Squeezers”; U.S. Pat. No. 2,829,588, which issued to Battke on Apr. 8, 1958 for “Lemon Slice Squeezers”; U.S. Pat. No. 3,027,826, which issued to Morris on Apr. 3, 1962 for “Hand Tool”; and finally, U.S. Pat. No. 4,286,514, which issued to Wilson on Sep. 1, 1981 for “Tea Bag Compressor.”

Similarly, there are numerous design patent prior art references directed to tea bag or other types of squeezers, as illustrated in U.S. Des. Pat. No. 173,542, which issued to Roberts on Nov. 23, 1954 for “Tea Bag Squeezer”; U.S. Des. Pat. No. 188,433, which issued to Nikitas, et al. on Jul. 19, 1960 for “Tea Bag Squeezer”; U.S. Des. Pat. No. 191,368, which issued to Sinoto on Sep. 19, 1961 for “Tea Bag Holder”; U.S. Des. Pat. No. 195,865, which issued to Sundquist on Aug. 6, 1963 for “Tea Bag Tong”; U.S. Des. Pat. No. 254,466, which issued to Carson on Mar. 18, 1980 for “Tea Bag Squeezer”; U.S. Des. Pat. No. 273,551, which issued to Kirby on Apr. 24, 1984 for “Lemon Squeezer”; U.S. Des. Pat. No. 299,803, which issued to Chow on Feb. 14, 1989 for “Lemon Squeezer”; U.S. Des. Pat. No. 366,188, which issued to Norenberg on Jan. 16, 1996 for “Combined Holder and Press for Tea-Bags”; and U.S. Des. Pat. No. 433,289, which issued to Durbin et al. on Nov. 7, 2000 for “Tea Bag Squeeze.”

As shall be appreciated, the prior art fails to specifically address either the problem or the solution arrived upon by applicant.

### SUMMARY OF THE INVENTION

Against the foregoing background, it is a primary object of the present invention to provide a squeezer for tea bags or other objects such as lemons and limes.

It is another object of the present invention to provide such a tea bag squeezer that allows a user to easily receive and compress a teabag so as to squeeze out liquid in the teabag or other objects.

It is yet another object of the present invention to provide such a tea bag squeezer that allows the user to squeeze a tea bag or other object without getting his fingers wet.

It is another object of the present invention to provide such a tea bag squeezer that can thereafter store the teabag or other object until discarded so as to hide the unsightly used teabag.

It is still another object of the present invention to provide such a tea bag squeezer that may be configured in an aesthetically pleasing design.

It is but another object of the present invention to provide such a tea bag squeezer that is ergonomically designed to allow for easy placement of fingers and thumbs.

It is yet another object of the present invention to provide such a tea bag squeezer that includes ribs on the squeezing surfaces to further compress the tea bag or other object and to direct the liquid out of the squeezer.

It is but another object of the present invention to provide such a tea bag squeezer that includes notched details to capture or retain the teabag string.

It is yet another object of the present invention to provide such a tea bag squeezer that may be manufactured of a variety of materials either inexpensive or otherwise.

To the accomplishments of the foregoing objects and advantages, the present invention, in brief summary, comprises a pair of complementary opposing members, said members each being concave in shape and having a tab extending from one end thereof. The members are attached to each other by means of a flexible hinge disposed between the concave members and the tabs. A spring is disposed at the flexible hinge, which spring serves to force the concave members against each other. A user can separate the concave members to thereby accept a tea bag by biasing squeezing the tab elements to thereby bias them towards each other. The concave members may thereafter be allowed to close about and squeeze the tea bag by releasing said tab members and allowing the force of the spring to compress the teabag or other item between the concave members. Ribbed elements may be provided on the inner surface of the concave members to further squeeze the item placed therein and direct the liquid out of the squeezer. In the preferred embodiment, the squeezer is configured in an aesthetically pleasing design, such as that of a scallop shell. Notches may be included on the surface of the squeezer to receive the string from the squeezer.

### BRIEF DESCRIPTION OF THE DRAWINGS

The foregoing and still other objects and advantages of the present invention will be more apparent from the detailed explanation of the preferred embodiments of the invention in connection with the accompanying drawings, wherein:

FIG. 1 is a top plan view of the tea bag squeezer of the present invention;

FIG. 2 is a side elevational view of the tea bag squeezer of FIG. 1 in the closed position;

FIG. 3 is a top plan view of a single compression element of the tea bag squeezer of FIG. 1; and

FIG. 4 is a side elevational view of the tea bag squeezer of FIG. 1 in the opened position.

### BRIEF DESCRIPTION OF THE PREFERRED EMBODIMENTS

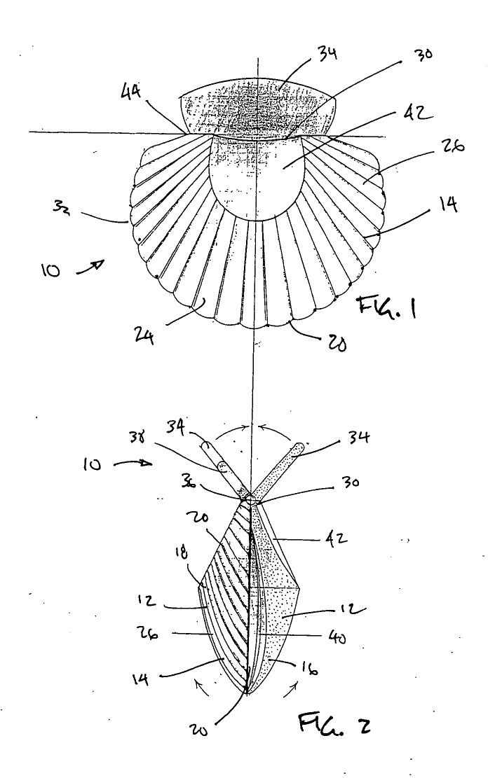

Referring to the drawings and, in particular, to FIGS. 1 and 2 thereof, the tea bag squeezer of the present invention is provided and is referred to generally by reference numeral 10. The tea bag squeezer 10 comprises a pair of complementary opposing compression elements 12, namely an upper element 14 and a lower element 16. The compression elements 12 each include a concavity 18 which cooperate to form a chamber 20 when the tea bag squeezer 10 is closed for receiving and retaining a tea bag or other item such as a slice or wedge of lemon or lime.

In the preferred embodiment, the size of the complementary elements 12 is such that a tea bag would fit completely within the chamber 20 and be hidden from view when the tea bag squeezer 10 is closed and the complementary elements 12 are immediately adjacent to each other. Numerous shapes to said elements 12 are also contemplated, including geometric shapes such as rectangles, ovals or circles, as well as other aesthetically pleasing shapes, such as that of a sea shell, as is illustrated in the Figures. It should be appreciated, however, that the sea shell shape illustrated in the Figures are merely but one embodiment of the design for the complementary elements 12, and that any number of other shapes may be used.

Each complementary element includes an inner surface 22 and an outer surface 24. The inner surface 22 defines the concavity 18, whereas the outer surface 24 may include ornamental or design features 26, such as the ribs of a scallop shell, to present an aesthetically pleasing appearance to the tea bag squeezer 10.

Each complementary element 12 also includes a front portion 28, a back portion 30 and side portions 32, wherein the front portion 28, the back portion 30 and the side portions 32 of each complementary element 12 are immediately adjacent to each other when the tea bag squeezer is in the closed position. Disposed along the back portion of each complementary element 12 is a squeeze tab 34 extending from the back portion 30.

The compression elements 12 are attached to each other by means of a flexible hinge 36 disposed between said compression elements 12 and said tabs 34 such that said compression elements 12 and tabs 34 form an X shape having the intersecting point being said hinge 36, as illustrated in FIG. 2. Thus the tab 34 corresponding to the upper element 14 would lie above the tab 34 corresponding to the lower element 16.

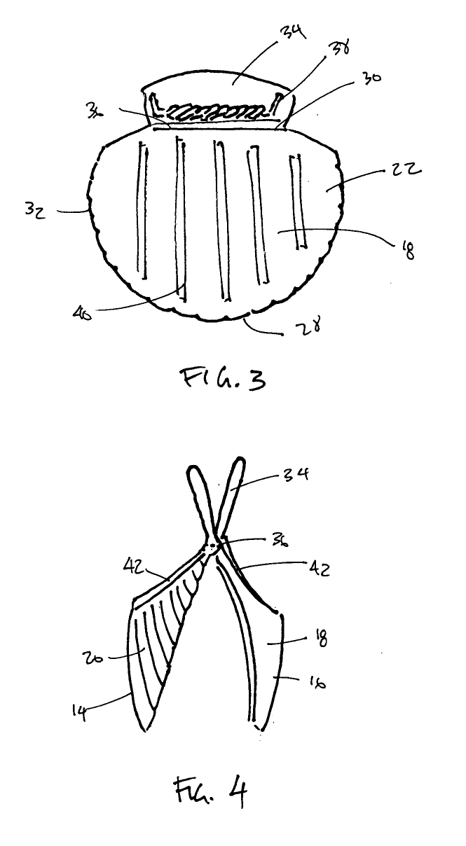

Disposed about the flexible hinge 36 is a spring 38 that serves to force compression elements 12 members against each other. In the preferred embodiment, the spring 38 is disposed between the squeeze tabs 34, as illustrated in FIG. 3, and the spring 38 is wound so as to provide force to separate said tabs 34. Alternatively, the spring 38 may be placed between the concavities 18 of the compression elements 12, wherein the spring is wound so as to provide force to draw said elements 12 towards each other to the closed position.

In actual operation, the compression elements 12 are separated to thereby reveal the chamber 20 and to accept a tea bag or other item therein by biasing said squeeze tabs 34 towards each other, as illustrated in FIG. 4. The compression elements 12 may thereafter be allowed to close about said tea bag by releasing the tabs 34 and allowing the force of the spring 38 to bias the elements 12 towards each other.

A plurality of fins or ribs 40 may be provided along the inner surface 22 of the complementary elements 12, said ribs 40 serving to further compress the tea bag or other object and to direct the liquid produced by such objects towards the front portion 28 of each of the elements 12. A finger press 42 may be provided on the outer surface 24 of either the upper element 14 or the lower element 16, which finger press 42 allows a user to further squeeze the two elements 14, 16 against each other to further compress any object placed therebetween.

Depending on the design of the tea bag squeezer 10, a notch or notches 42 may also be provided, preferably along the hinge 36, said notch 42 serving to accept the string from the tea bag, allowing a user to wrap the string around the tea bag squeezer 10 about said notch 42.

A wide variety of materials are anticipated for the manufacture of the squeezer 10, ranging from inexpensive materials such as plastic to more expensive materials and semi-precious metals, such as silver.

Having thus described the invention with particular reference to the preferred forms thereof, it will be obvious that various changes and modifications can be made therein without departing from the spirit and scope of the present invention as defined by the appended claims.

1. A squeezer for tea bags and other objects comprising a pair of complementary opposing compression elements each having a front portion, side portions and a back portion, said compression elements each comprising an inner surface and an outer surface, wherein said inner surfaces each define a concavity and wherein said concavities cooperate to form a chamber, wherein said compression elements further comprise a tab extending from said back portion, and wherein said compression elements are attached to each other by means of a flexible hinge disposed between said compression elements and said tabs, said flexible hinge further including a spring that serves to force said compression elements against each other such that said front portions, said back portions and said side portions are immediately adjacent to each other, wherein said compression elements may be separated to thereby accept said tea bag by biasing said tab elements towards each other and said compression elements may thereafter be allowed to close about said tea bag by releasing said tab members and allowing said spring to force said tab elements apart.

2. The squeezer of claim 1, further including a plurality of ribs disposed on said interior surface, said ribs being designed to engage and compress said tea bag and direct any liquid towards said front portion of said compression elements.

3. The squeezer of claim 2, wherein said outer surface and said tabs are formed so as to represent the shape of a sea shell.

4. The squeezer of claim 3, wherein said exterior surface further includes a finger surface disposed adjacent to said hinge, wherein said finger surfaces may be compressed to bias said concave members towards each other and to further compress said tea bag.

5. The squeezer of claim 4, further including a notch disposed between said tabs and said concave members, said notch being designed to receive a string from said tea bag.

6. The squeezer of claim 5, wherein said chamber is large enough to receive and conceal said tea bag when said compression elements are biased against each other in a closed position.

7. The squeezer of claim 6, wherein said concave members and said tabs are manufactured from semi-precious metal.

8. The squeezer of claim 6, wherein said concave members and said tabs are manufactured from plastic.

9. A squeezer for tea bags and other objects comprising a pair of complementary opposing compression elements each having a front portion, side portions and a back portion, said compression elements each comprising an inner surface and an outer surface and wherein a plurality of ribs is disposed on said interior surfaces, wherein said inner surfaces each define a concavity and wherein said concavities cooperate to form a chamber large enough to receive and conceal said tea bag when said compression elements are biased against each other in a closed position, wherein said compression elements further comprise a tab extending from said back portion, and wherein said compression elements are attached to each other by means of a flexible hinge disposed between said compression elements and said tabs, said flexible hinge further including a spring that serves to force said compression elements against each other such that said front portions, said back portions and said side portions are immediately adjacent to each other, wherein said compression elements may be separated to thereby accept said tea bag by biasing said tab elements towards each other and said compression elements may thereafter be allowed to close about said tea bag by releasing said tab members and allowing said spring to force said tab elements apart, and wherein said outer surface and said tabs are formed so as to represent the shape of a sea shell.
